(19) United States
(12) Patent Application Publication
(10) Pub. No.: US 2007/0151788 A1
(43) Pub. Date: Jul. 5, 2007

(54) Turbo supercharger kit for motorcycles

(76) Inventor: Andrew K. Runolfson, Alpine, UT (US)

Correspondence Address: Angus C. Fox, III, 4093 N. Imperial Way, Provo, UT, 84604-5386, US

(21) Appl. No.: 11/471,888

(22) Filed: Jun. 20, 2006

Related U.S. Application Data
(60) Provisional application No. 60/692,612, filed on Jun. 20, 2005.

(51) Int. Cl. B62K 11/00

(52) U.S. Cl. 180/219

(57) ABSTRACT

In combination with a motorcycle having a frame, a rear suspension swing arm pivotally mounted about a pivot axis to a lower rear portion of said frame, a rear wheel suspended from said swing arm via a rear axle, an upper rear extension of the frame extending above said rear wheel, and an internal combustion engine mounted to the frame between the front and rear wheels, the internal combustion engine having at least one induction port and at least one exhaust port, a turbosupercharger system including a turbosupercharger mounted to and beneath the upper rear extension, the turbosupercharger having a turbine stage with intake and exhaust ports and a compressor stage with an ambient air inlet and a compressed air outlet; a discharge pipe which couples the turbine intake to the exhaust port(s); and an induction pipe which couples the compressed air outlet to the induction port(s).

This application has a priority date based on Provisional Patent Application No. 60/692612, by the same inventor, which was filed on Jun. 20, 2005.

### BACKGROUND OF THE INVENTION

1. Field of the Invention

This invention relates to a motorcycle with a turbo-charger and more particularly to an improved arrangement for locating and driving the turbo-charger within the confines of the motorcycle.

2. History of the Prior Art

A turbosupercharger or, simply, turbocharger, is a supercharging device driven by the high velocity exhaust gases of an internal combustion engine. A turbocharger comprises a turbine and a compressor mounted on opposite ends of a rotatable shaft. The turbine, driven by hot gases from the engine exhaust manifold, spins the compressor. The compressor increases the density of the air provided to the engine intake manifold. The greater air density, combined with additional fuel, enables the engine to produce more power than a normally-aspirated equivalent engine. Modern turbochargers always use centrifugal-flow compressors, which operate efficiently at the high rotational speeds produced by the exhaust turbine.

The year 2005 marks 100 years of turbocharger technology. In 1905, Dr. Alfred Büchi, chief engineer at Sulzer Brothers Research and Development, filed a patent for the first turbocharger—a power unit comprising an axial compressor, a radial piston engine and an axial turbine on a common shaft. In 1915, Büchi produced a prototype that demonstrated how the energy generated by the exhaust gases of an aircraft could be used to counter the negative effects of diminishing air density at high altitude.

In 1919, General Electric successfully coupled a turbocharger to the Liberty V-12 engine of a Lepere biplane, which then set an altitude record of 10,092 meters (ee,113 feet). Nevertheless, it was not until World War II that the full potential of turbocharging was realized. Tens of thousands of General Electric units were coupled to both the Wright R-1820 engines installed in the Boeing B-17 bomber aircraft and the Allison V-1710 engines installed in the Lockheed P-38 fighter aircraft. In 1939, the twin-engine, twin-boom P-38 fighter was the fastest production aircraft in the world, with a maximum speed of 414 mph, a range of 1,100 miles and a service ceiling of 40,000 feet.

During the early 1950s, when the Caterpillar Tractor Co. was designing powerful, new, heavy-duty earth-moving equipment, it contracted with the Garrett Corporation for the development of a turbocharger, which was subsequently used on its extremely popular D9 bulldozer tractor. The success of the T15 turbocharger on Caterpillar equipment prompted the Garrett Corporation to launch the AiResearch Industrial Division—a business dedicated solely to the design and manufacture of turbochargers.

In the early to mid-1960s, General Motors Corporation developed a number of new automobiles that represented the cutting edge of global automotive technology. One of those vehicles was the 1961 Oldsmobile F-85, a compact car equipped with an aluminum-block V-8 engine of about 3.5 liter displacement. Amazingly, the same basic engine is still used today in the British-made Range Rover. For 1962, a high-performance version of the F-85, known as the Jetfire, was introduced. Equipped with a water/alcohol injection system and a Garrett T05 turbocharger with an internal wastegate that provided a maximum intake boost of 5 p.s.i., the Jetfire managed to produce 1 horsepower for each of its 215 cubic inches of displacement. Although a milestone in automotive development, the Jetfire was a commercial failure due to the complexity of liquid-injection system.

Twelve years after the demise of the Oldsmobile Jetfire, the 1975 Porsche 911 Turbo finally demonstrated that turbocharging had come of age. The Porsche was followed by the 1977 Saab 99 Turbo, the 1977 Mercedes Benz 300 SD and a host of others. Today, nearly every commercial diesel-powered vehicle is equipped with a turbocharger, as is nearly every diesel-powered automobile.

Turbochargers provide a number of significant benefits. Turbochargers recover significant amounts of heat and kinetic energy from the exhaust gases of internal combustion engines. This energy, which would otherwise be lost, is transformed into power. Turbocharged combustion is more fuel efficient and cleaner. For gasoline passenger cars, turbocharging contributes to CO₂ reduction by delivering 10-20% better fuel efficiency than a non-turbocharged car of equal power. For turbo diesel vehicles, the fuel efficiency gain is 30-50% better than a non-boosted gasoline vehicle. It has become very clear that modern turbochargers have dramatically improved the driveability, power and fuel efficiency of diesel automobiles. As a consequence of both that realization and the high cost of automotive fuels in Europe, one of every two European cars is now a diesel.

In 1981, Honda Motor Corporation introduced the CX500—the world's first production turbocharged motorcycle. Two years later, Honda introduced the CX650, a similar bike with an enlarged, 100-horsepower, fuel-injected engine that provided a top speed of 140 m.p.h. Not to be outdone by its larger rival, Yamaha, Kawasaki and Suzuki each produced a single turbocharged model, with the Kawasaki ZX750T—a bike with a top speed of 140 and a standing start quarter mile time of less than eleven seconds—being clearly the best of the litter. In spite of the obvious advantages of turbocharging, the major Japanese motorcycle manufacturers have not produced a turbocharged production motorcycle for nearly twenty years. During that same period, tremendous advances in engine technology have endowed normally-aspirated 600 cc sport bikes with acceleration and top-speed performance that rivals that of the Kawasaki ZX750T. In addition, the 600 cc sportbikes for the year 2005 all weigh less than 400 pounds (about 182 kilograms), have engines capable of producing more than 100 horsepower, provide impecable high-speed handling, and are endowed with disc brakes that generate deceleration forces that even rocket sled tester Col. John Stapp would love.

A decade or so ago, 600 cc sportbikes were considered to be non-intimidating, lightweight, entry-level motorcycles having manageable power delivery. How things have changed! The current generation of 600 cc sportbikes can lap a racetrack quicker than a liter-class bike from less than a decade ago. Appealing to professional racers and neophytes alike, the 600 cc class is the most popular sportbike category, despite the recent upsurge in demand for terrifyingly powerful superbikes having one liter or more displacement. Given the popularity of the 600 cc class, the Japanese motorcycle manufacturers have made competition in that market segment a priority.

For some individuals, blinding top speed and acceleration is simply a starting point for even more outrageous performance. The idea of installing a turbocharger on a medium-displacement motorcycle and boosting the horsepower output to 150 or more with little or no increase in curb weight is nothing short of outrageous. However, one of the major problems associated with the installation of a turbocharger on a 600 cc motorcycle is that of lack of space in front of the engine, a problem inherent in the compact design of these bikes. Ideally, a turbocharger should be mounted as close to the exhaust manifolds as possible, in order to avoid heat and kinetic energy loss from the exhaust gases while en route to the turbocharger. U.S. Pat. No. 4,396,085 to Inoue, et al. discloses such a configuration. Unfortunately, there is insufficient space for the installation of a turbocharger in front of the engine on all 600 cc offerings from Honda, Kawasaki, Suzuki and Yamaha.

U.S. Pat. No. 4,469,189 to Minami, et al. discloses a motorcycle having a turbocharger that is fed from the exhaust collector pipe positioned beneath the engine. The turbocharger is positioned between the engine and the rear wheels. A splash shield mounted between the rear wheel and the turbocharger, protects the latter from mud and water. Unfortunately, none of the 600 cc sportbikes from Japan have sufficient room between the engine and the rear wheel.

What is needed is a turbocharger configuration for medium displacement sportbikes that is suited for factory, as well as aftermarket installations.

### SUMMARY OF THE INVENTION

This invention is adapted to be embodied in a motorcycle having a frame assembly, a rear fender/seat assembly mounted atop a rear portion of the frame assembly, front and rear wheels suspended from said frame assembly, an internal combustion engine having an intake manifold and a plurality of exhaust pipes passing beneath the engine and merging into a common collector. In accordance with the invention, the turbocharger is positioned above the rear wheel and below the rear fender/seat assembly. A discharge pipe couples the collector to the turbine stage of the turbocharger. For a preferred embodiment of the invention, the discharge pipe closely follows the route of the standard muffler, which has been removed for aftermarket installations. An induction pipe couples the compressor stage of the turbocharger to the intake manifold, thereby delivering a boost to the intake charge. The turbocharger may be suspended from the rear fender/seat assembly, or it may be supported by brackets attached directly to the frame. For a preferred embodiment of the invention, the axis of the turbocharger shaft is generally parallel to and positioned behind the rear axle. A pressurized oil line is routed from the engine to the turbocharger and a return oil line is routed from the turbocharger to the engine.

### BRIEF DESCRIPTION OF THE DRAWING

FIG. 1 is a right side elevational view of a Honda CBR 1000RR motorcycle;

FIG. 2 is a side elevational view of the right-rear portion of a Kawasaki ZX636R motorcycle, which incorporates the invention;

FIG. 3 is rear-right-side view of the Kawasaki AX636R motorcycle of FIG. 2;

FIG. 4 is a side elevational view of the left-rear portion of the Kawasaki ZX636R motorcycle of FIG. 1;

FIG. 5 is an upper-right-side view of the center portion of the Kawasaki ZX636R of FIG. 2;

FIG. 6 is a downward view of the intake plenum and intake manifold of the Kawasaki ZX636R of FIG. 2; and

FIG. 7 is a close-up view taken from the rear of the Kawasaki AX636R motorcycle of FIG. 2, showing the air filter, waste gate and actuator valve.

### DETAILED DISCLOSURE OF THE INVENTION

The invention will now be described in detail with reference to the attached black-and-white digital photographs. For this disclosure, the invention has been installed on a 2003 Kawasaki AX636R sportbike.

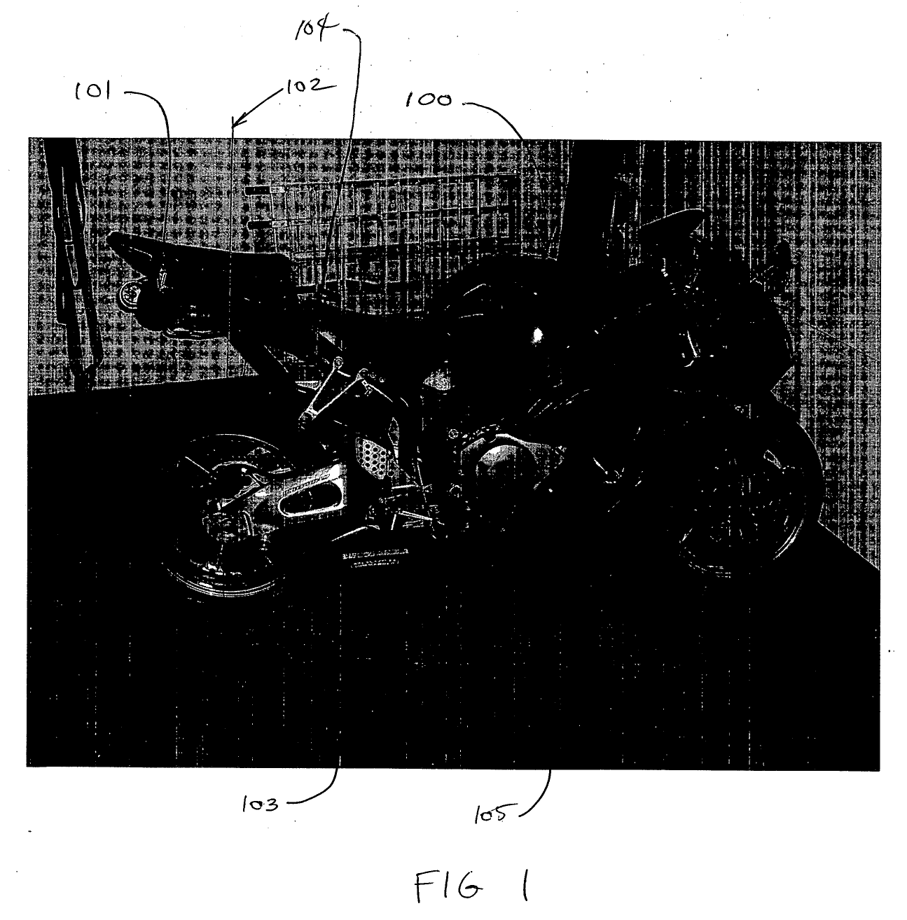

Referring now to FIG. 1, a Honda CBR 1000RR 100 is shown on which has been installed a turbocharger 101 in accordance with the present invention. It will be noted that the turbocharger 101 is generally aft of a vertical plane 102 passing through the axle of the rear wheel 103. Also visible in this view is the discharge pipe 104 which couples the exhaust collector (not visible in this view) of the engine 105 to the input port of the turbine stage of the turbocharger 101.

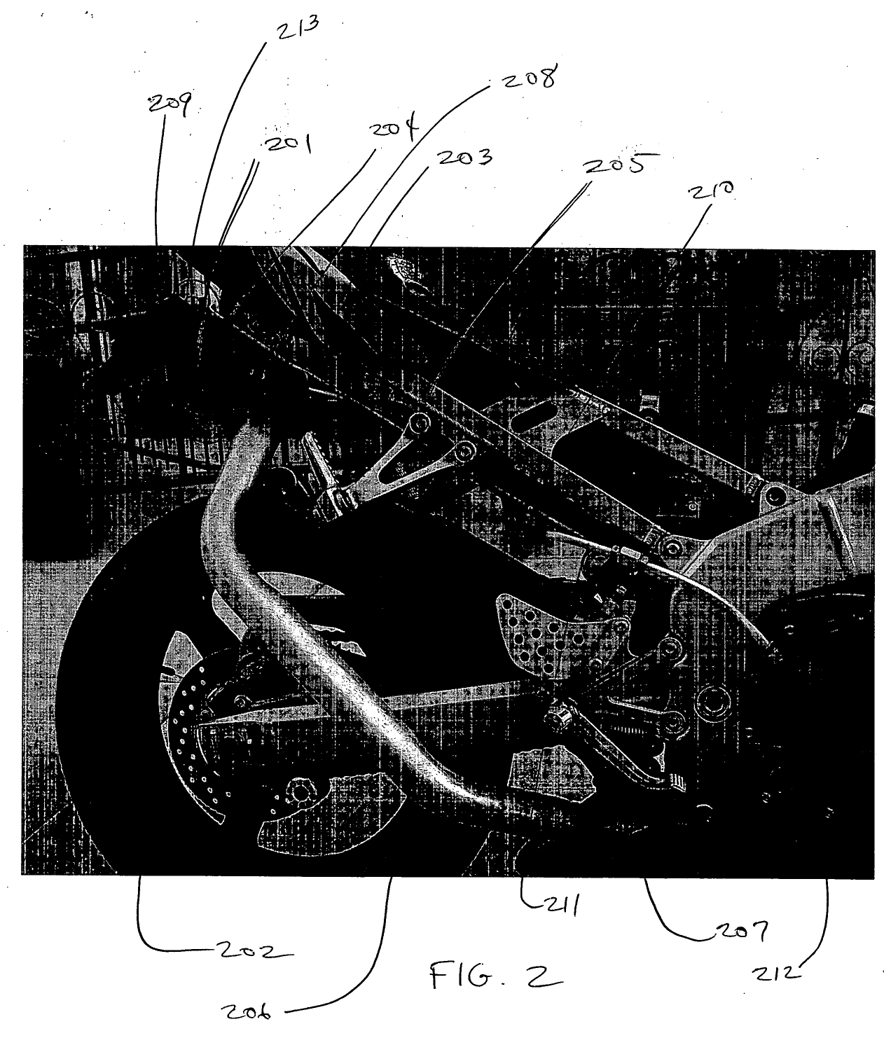

Referring now to FIG. 2, a Garrett GT-15 turbocharger 201 has been mounted above the rear wheel 202 and below the rear fender/seat assembly 203. A bracket 204 secures the turbocharger 201 to an upper rear frame extension 205 either directly or indirectly by attaching it to the rear fender/seat assembly 203, which is directly attached to the upper rear frame extension 205. A discharge pipe 206 couples the exhaust pipe collector 207 to the intake port 208 of the turbine stage 209 of the turbocharger 201. For a preferred embodiment of the invention, the discharge pipe 206 closely follows the route of the standard muffler, which has been removed for this aftermarket installation. A pressurized oil line 210 is routed from the engine's oil pressure sensor takeoff (now shown). A return oil line 211 is routed from the turbocharger 201 to the engine oil dipstick cap 212. It will be noticed that an exhaust tip (not shown) has been removed from the turbine side of the turbocharger 201, thereby exposing the turbine exhaust port 213. With the exhaust tip in place, the exhaust gases would exit on the right side of the license plate.

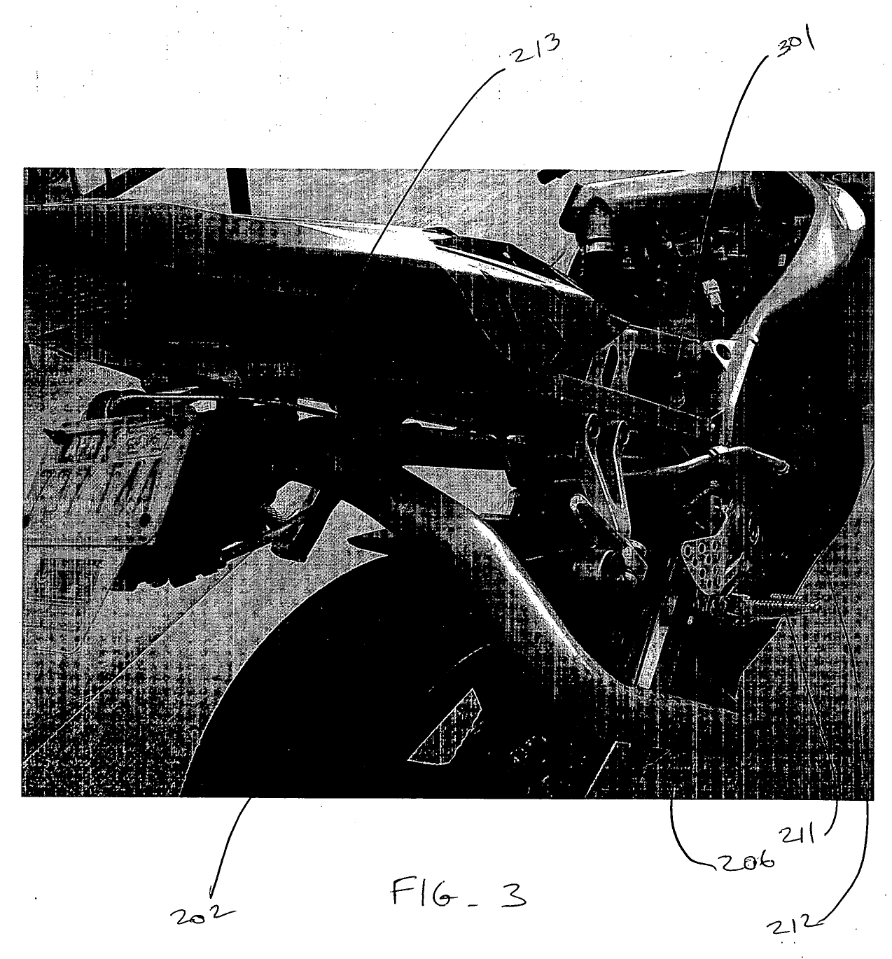

Referring now to FIG. 3, the turbocharger system is seen from a different perspective. In this view the oil pressure sensor takeoff 301 is visible.

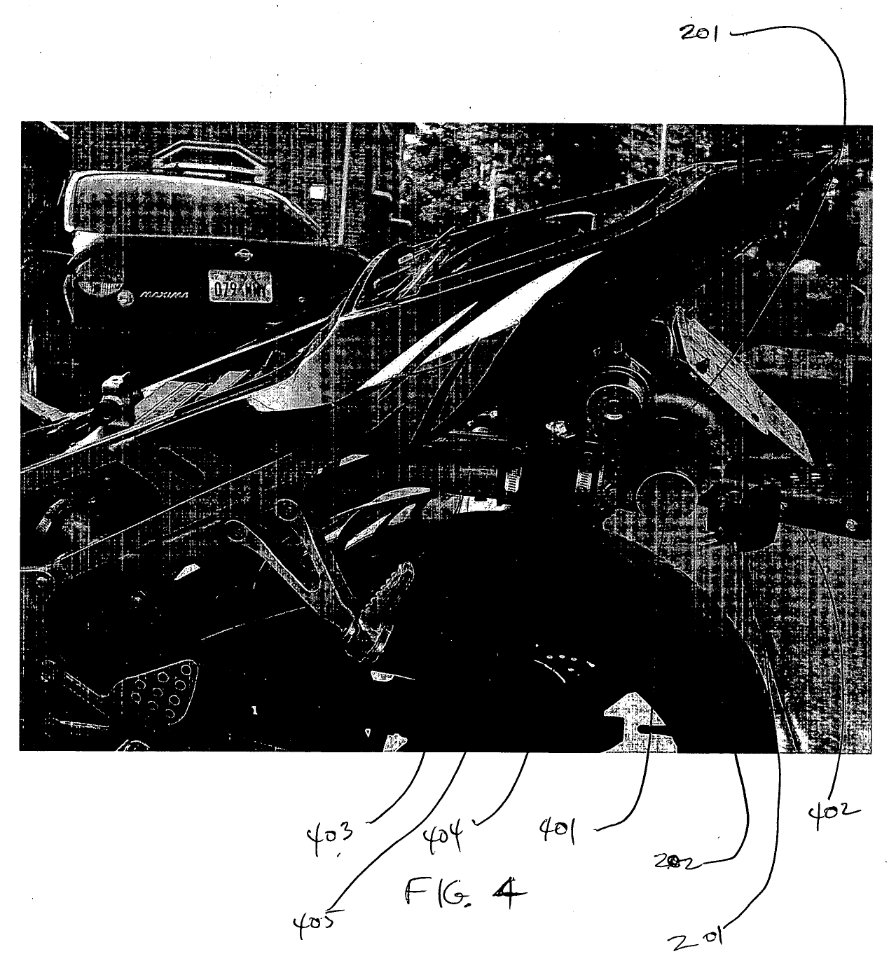

Referring now to FIG. 4, a K&N air filter 401 protects the ambient air inlet (not visible in this view of the compressor stage 402 of turbocharger 201 from dirt and debris. An induction pipe 403 couples the compressed air outlet 404 of the compressor stage 402 of turbocharger 201 to the intake manifold (not shown in this view). The induction pipe 403 is coupled to compressed air outlet 404 with a rubber hose 405.

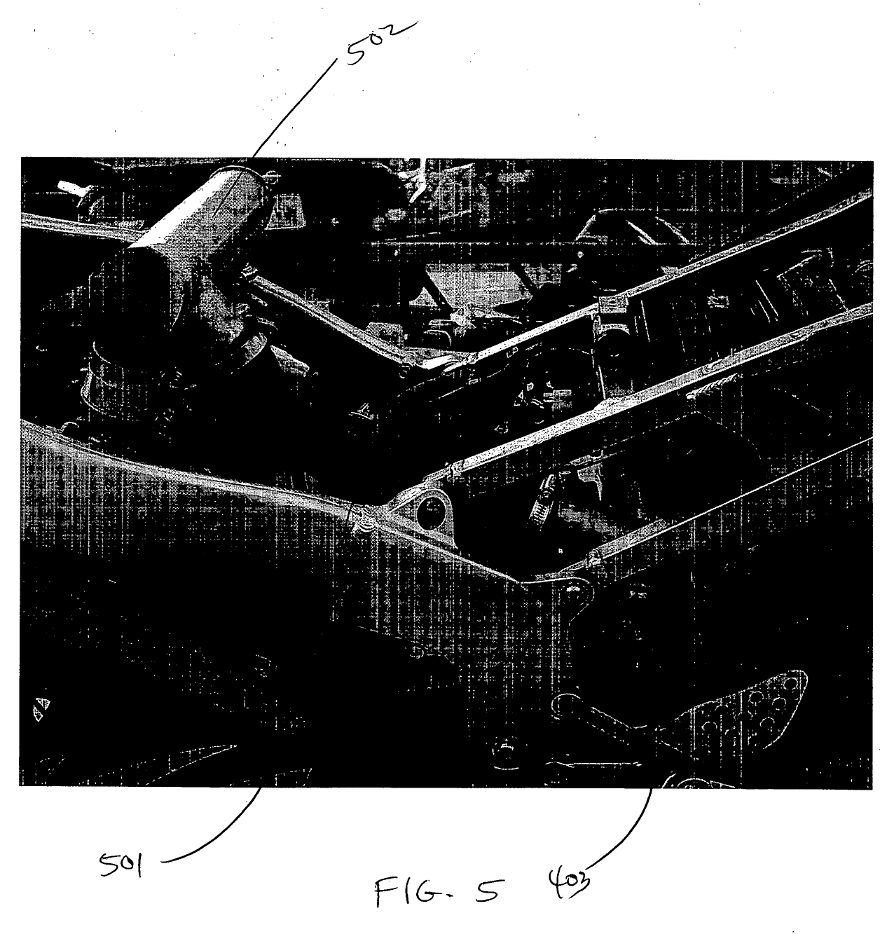

Referring now to FIG. 5, it will be noted that an ovalized rubber hose 501 functions as a portion of the induction pipe 403 where routing through the frame is particularly tight. More specialized metal bending and forming operations may eliminate a major portion or all of the ovalized rubber hose 501. It will be noted that the ovalized rubber hose 501 is coupled to an intake plenum 502, which feeds the intake manifold (not shown in this view).

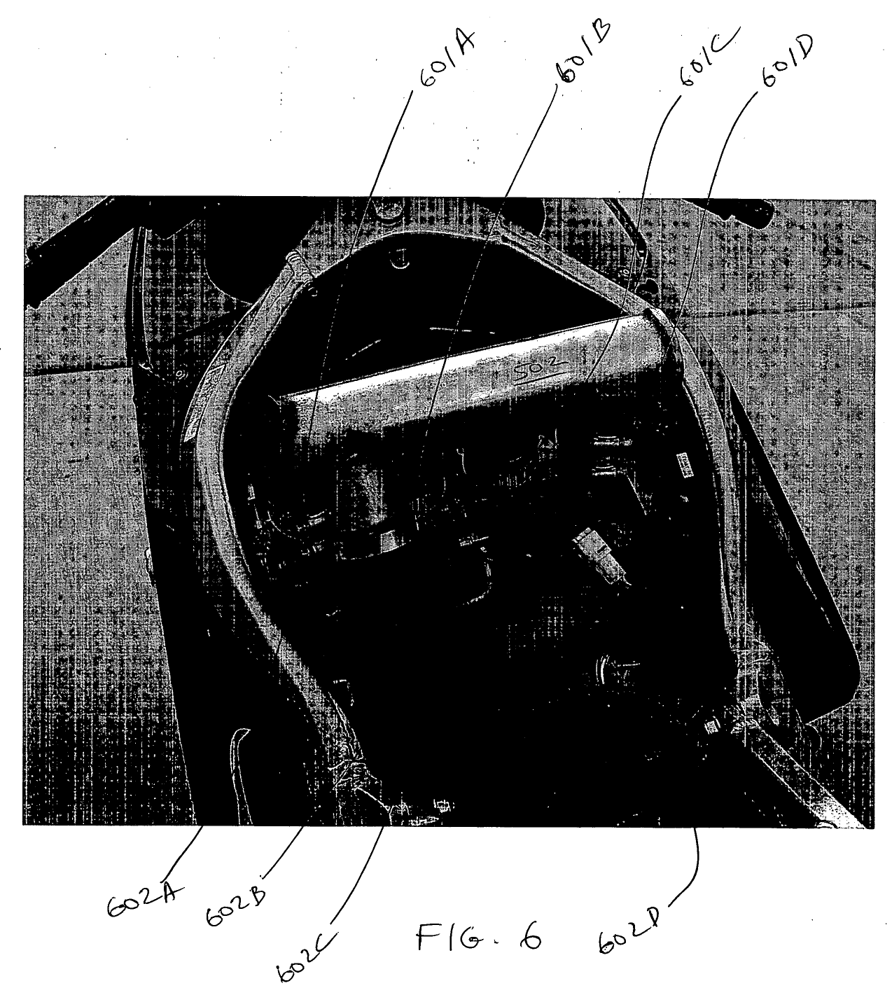

Referring now to FIG. 6, the plenum 502 has four tubular extensions 601A-D, each of which feed a single cylinder intake port 602A-D.

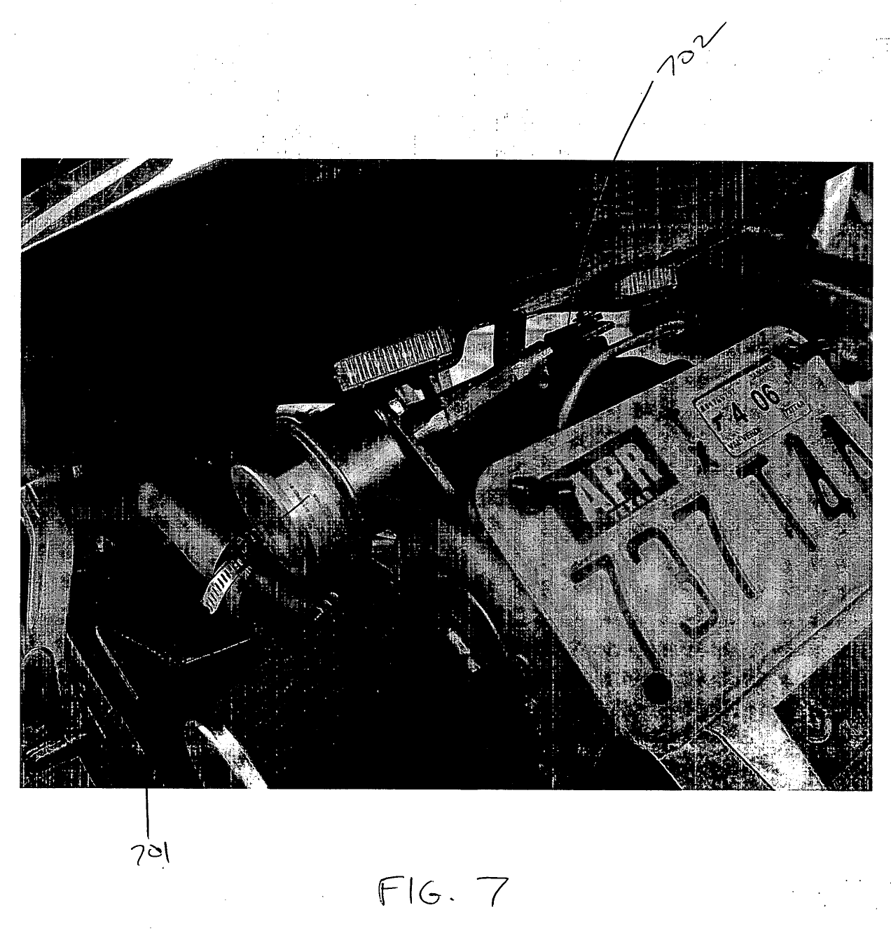

Referring now to FIG. 7, a waste gate actuator 701 senses boost pressure and actuates the waste gate valve lever 702 when boost exceeds a set value, thereby minimizing the possibility that the engine will be overstressed.

Although only several embodiments of the present invention has been disclosed herein, it will be obvious to those having ordinary skill in the art that changes and modifications may be made thereto without departing from the scope and spirit of the invention as hereinafter may be claimed.

What is claimed is:

1. In combination with a motorcycle having a frame, a fork and front suspension assembly pivotally mounted to an upper front portion of said frame, a front wheel suspended from said fork and front suspension assembly, a rear suspension swing arm pivotally mounted about a pivot axis to a lower rear portion of said frame, a rear wheel suspended from said swing arm via a rear axle, an upper rear extension of said frame extending above said rear wheel and supporting a seat and rear fender assembly, and an internal combustion engine mounted to said frame between said front and rear wheels, said internal combustion engine having at least one induction port and at least one exhaust port, a turbosupercharger system comprising:
a turbosupercharger mounted to and beneath said upper rear extension, said turbosupercharger having a turbine stage with intake and exhaust ports and a compressor stage with an ambient air inlet and a compressed air outlet;
a discharge pipe which couples the turbine intake to said at least one exhaust port; and
an induction pipe which couples said compressed air outlet to said at least one induction port.

2. The combination of claim 1, wherein said turbosupercharger is positioned generally aft of a vertical plane passing through said pivot axis.

3. The combination of claim 2, wherein said turbosupercharger is positioned generally aft of a vertical plane passing through said rear axle.

4. The combination of claim 1, which further comprises an exhaust collector that couples multiple exhaust ports to said discharge pipe.

5. The combination of claim 1, which further comprises an intake manifold that couples multiple induction ports to said induction pipe.

6. The combination of claim 1, wherein for conversions of non-turbo motorcycles, said turbosupercharger and said discharge pipe replace a conventional muffler system which was originally installed on the motorcycle.

7. In combination with a motorcycle having a frame, a fork and front suspension assembly pivotally mounted to an upper front portion of said frame, a front wheel suspended from said fork and front suspension assembly, a rear suspension swing arm pivotally mounted about a pivot axis to a lower rear portion of said frame, a rear wheel suspended from said swing arm via a rear axle, and an internal combustion engine mounted to said frame between said front and rear wheels, said internal combustion engine having at least one induction port and at least one exhaust port, a turbosupercharger system comprising:
a turbosupercharger positioned aft of a vertical plane passing through said pivot axis, said turbosupercharger having a turbine stage with intake and exhaust ports and a compressor stage with an ambient air inlet and a compressed air outlet;
a discharge pipe which couples the turbine intake to said at least one exhaust port; and
an induction pipe which couples said compressed air outlet to said at least one induction port.

8. The combination of claim 7, wherein said turbosupercharger is positioned generally aft of a vertical plane passing through said rear axle.

9. The combination of claim 7, which further comprises an exhaust collector that couples multiple exhaust ports to said discharge pipe.

10. The combination of claim 7, which further comprises an intake manifold that couples multiple induction ports to said induction pipe.

11. The combination of claim 7 wherein for conversions of non-turbo motorcycles, said turbosupercharger and said discharge pipe replace a conventional muffler system which was originally installed on the motorcycle.

12. A turbosupercharger system for a motorcycle having front and rear wheels suspended from a frame assembly, and an internal combustion engine with an intake manifold and an exhaust collector mounted to said frame assembly between said wheels, said turbosupercharger system comprising:
a turbosupercharger positioned aft of a vertical plane passing through a rotatational axis of said rear wheel, said turbosupercharger having a turbine stage with intake and exhaust ports and a compressor stage with an ambient air inlet and a compressed air outlet;
a discharge pipe which couples the turbine intake to said exhaust collector; and
an induction pipe which couples said compressed air outlet to said intake manifold.

13. The combination of claim 12, wherein for conversions of non-turbo motorcycles, said turbosupercharger and said discharge pipe replace a conventional muffler system which was originally installed on the motorcycle.
